(19) United States
(12) Patent Application Publication
(10) Pub. No.: US 2009/0078789 A1
(43) Pub. Date: Mar. 26, 2009

(54) FLUID RESERVOIR FOR A PAINT SPRAY GUN

(76) Inventor: Albrecht Kruse, Stuttgart (DE)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/574,599

(22) PCT Filed: Aug. 13, 2005
(86) PCT No.: PCT/EP05/08836

§ 371 Date: Jul. 2, 2008

(30) Foreign Application Priority Data
Sep. 7, 2004 (DE) 10 2004 043 599.5

(51) Int. Cl. B05B 7/24; B05B 7/30

(52) U.S. Cl. 239/345; 239/379

(57) ABSTRACT

The invention relates to a fluid reservoir for a paint spray gun, comprising a cup-shaped receptacle (1), a lid (2) that can be placed thereon (1) and a connecting part (3) which can be formed on the receptacle (1) or on the cover (2) and which is used to secure the fluid reservoir to the paint spray gun. According to the invention, a transition area (12) between the connecting part (3) and the receptacle (1) or the cover is embodied in a flexible manner in order to adjust the inclination of the receptacle (1) or the cover (2) in relation to the central axis (14) of the connecting part (3) in order to improve material guiding, even when the paint spray gun is inclined positions.

### FIELD OF THE INVENTION

The invention pertains to a fluid reservoir for a paint spray gun.

### BACKGROUND OF THE INVENTION

Conventional fluid reservoirs for paint spray guns usually feature a cup-shaped receptacle, the underside of which is provided with an opening and a connecting part for detachably connecting the receptacle to the upper side of the paint spray gun. The connecting part is usually realized in the form of a connection piece that is arranged on the bottom of the receptacle and features an external thread that is screwed into a corresponding threaded opening on the upper side of the paint spray gun. In conventional fluid reservoirs, the connecting part is normally arranged rigidly on the receptacle. However, this results in the receptacle assuming a horizontal or nearly horizontal position when it is attached to the paint spray gun and the paint spray gun is held in certain inclined positions. In this case, the feed of the paint to the paint spray gun may no longer be ensured under certain circumstances.

### SUMMARY OF THE INVENTION

The invention is based on the objective of developing a fluid reservoir of the initially mentioned type that makes it possible to improve the material feed, namely also when the paint spray gun is held in inclined positions.

This objective is attained with a fluid reservoir with the characteristics as set forth in the claims. Practical embodiments and advantageous additional refinements of the invention form the objects of the dependent claims.

One significant advantage of the inventive fluid reservoir can be seen in that the fluid receptacle can be inclined relative to the connecting part. If so required, the inclination of the fluid reservoir attached to the paint spray gun can be changed in order to also ensure the inflow of paint if the paint spray gun is significantly inclined. This adjustability is realized in that the transition area between the connecting part and the receptacle or the cover is realized in a flexible fashion. The connecting part for detachably Fixing the fluid reservoir on the paint spray gun may be arranged on the receptacle or on the cover. If the connecting part is arranged on the cover, the receptacle is situated upside down in its operative position.

In one embodiment of the invention that provides certain advantages with respect to the manufacturing technology, the wall thickness changes from a greater wall thickness on the connecting part to a lesser wall thickness on the receptacle or the cover in the transition area between the connecting part and the receptacle or the cover.

In another embodiment, the transition area may also be realized, for example, in the form of a bellows or the like.

### BRIEF DESCRIPTION OF THE DRAWINGS

Other special features and advantages of the invention result from the following description of one preferred embodiment that refers to the figures. Shown are:

FIG. 1, a first embodiment of an inventive fluid reservoir with a straight and an inclined connecting part, wherein the areas X and Y are illustrated in an enlarged fashion, and

FIG. 2, a second embodiment of an inventive fluid reservoir with a straight and an inclined connecting part, wherein the areas X and Y are illustrated in an enlarged fashion.

### DETAILED DESCRIPTION OF THE INVENTION

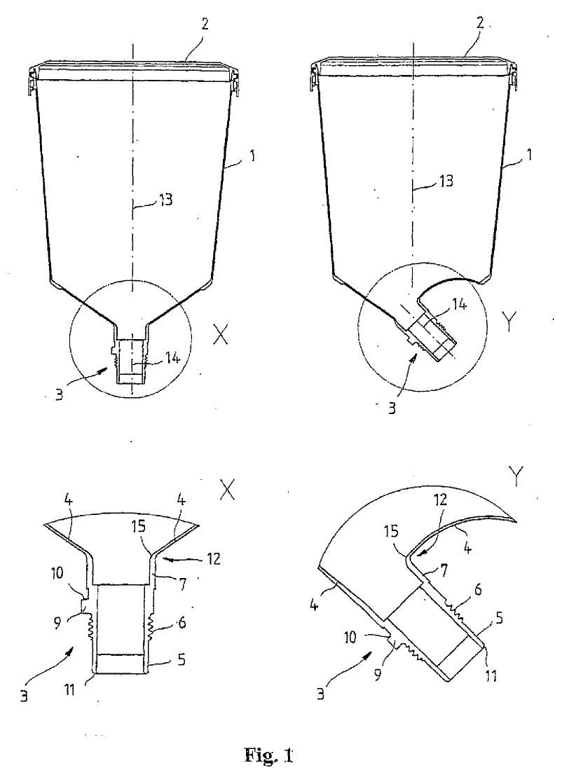

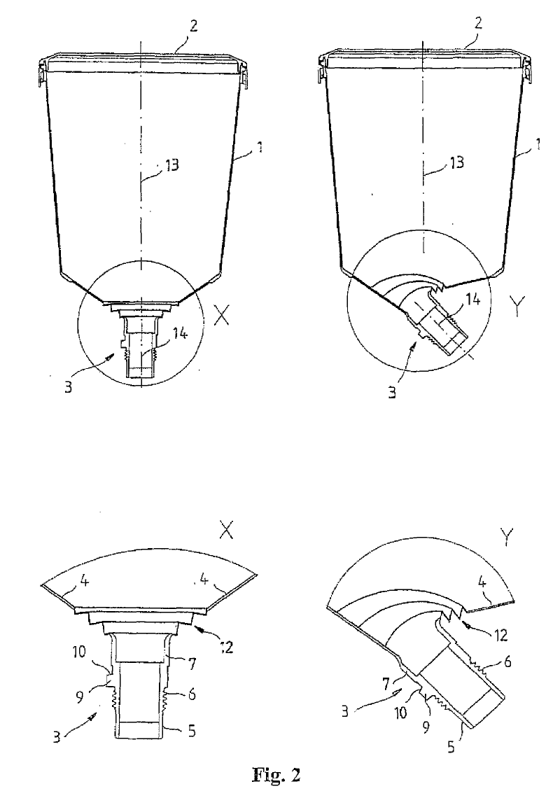

The fluid reservoirs for a paint spray gun illustrated in FIGS. 1 and 2 comprise a cup-shaped receptacle 1, a cover 2 that can be attached to the receptacle 1 and a connecting part 3 that is integrally molded onto the receptacle 1 and that serves for detachably fixing the receptacle 1 on a paint spray gun. The receptacle 1 with the connecting part 3 integrally molded thereon as well as the cover 2 are realized in the form of injection-molded parts of an elastic, non-embrittling plastic material. These requirements are fulfilled, e.g., with plastics consisting of PE or plastics with high PE content.

The enlarged details X and Y in FIGS. 1 and 2 show that the connecting part 3 consists of a tubular connection piece that is integrally molded or otherwise integrally connected to the conical bottom 4 of the receptacle 1, wherein this tubular connection piece comprises a hollow-cylindrical front area 5, an adjacent external thread 6 for screwing into a conventional internal thread, a screw-type wedge element that is arranged above the external thread 6 and that serves for realizing a rapid-action coupling between the fluid reservoir and the paint spray gun, and an upper insert area 7 with an inner annular contact surface 8 for inserting a conventional filter. In the embodiment shown, the screw-type wedge element is formed by a wedge-shaped projection 9 with a wedge surface 10 that extends approximately over half the circumference of the connecting part 3 and engages with a corresponding mating surface on an attachment or projection of the paint spray gun. The projection 9 with the wedge surface 10 and the corresponding mating surface on the paint spray gun are realized in such a way that the receptacle 1 can already be tightly fixed on the paint spray gun by turning the two components relative to one another by one-quarter to one-half revolution. The front face 111 of the connecting part 3 is pressed against a corresponding sealing surface within the paint spray gun in this case. The additional external thread 6 makes it possible to utilize the fluid reservoir on paint spray guns that are not equipped with a corresponding fitting for the screw-type wedge element, but rather a conventional internal thread.

In the fluid reservoirs shown in FIGS. 1 and 2, the transition area 12 between the connecting part 3 and the bottom 4 of the reservoir 1 is realized in a flexible fashion such that the angular position of the central axis 13 of the reservoir 1 can be adjusted relative to the central axis 14 of the connecting part 3. The transition area 12 is realized in such a way that the reservoir 1 can be held at a desired incline after it is screwed on the paint spray gun and does not automatically pivot back into its normal position. If so required, the reservoir 1 can be pivoted back into its normal position or into another inclined position. The fluid reservoir is illustrated in its normal position in the left portions of FIGS. 1 and 2. In this position, the central axis 13 of the reservoir 1 coincides with the central axis 14 of the connecting part 3. In the right portions of these figures, the reservoir 1 is inclined relative to the connecting part 3. The central axis 14 of the connecting part 3 is angled relative to the central axis 13 of the reservoir 1 in this case.

In the embodiment shown in FIG. 1, the transition area 12 between the connecting part 3 and the reservoir 1 is realized in such a way that the wall thickness changes from a greater wall thickness on the insert area 7 of the connecting part 3 to a lesser wall thickness on the bottom 4 of the reservoir. The difference in wall thickness at the transition area amounts to at least 30%. This ensures that the bottom 4 of the reservoir 1 can be bent without creating cracks and that any impairment of the insert area 7 of the connecting part 3 is simultaneously prevented. Due to this measure, the inner contour of the connecting part 3 that accommodates the filter is also maintained when the reservoir 1 is pivoted. A radius 15 is provided at the transition from the connecting part 3 to the bottom 4 of the reservoir 1. This ensures that the reservoir 1 is not damaged or bent in this region when it is inclined.

In the embodiment shown in FIG. 2, the transition area 12 is realized in the form of a bellows. The reservoir 1 can also be inclined relative to the connecting part 3 in this embodiment.

The invention is not limited to the embodiments that were described above and are illustrated in the figures. For example, the connecting part 3 may also be integrally molded to the cover. In this case, the reservoir may have a conventional cup-like shape with a straight bottom surface that does not feature a connecting part. The cover provided with the connecting part can be attached to the reservoir after it is filled and the fluid reservoir can then be inserted into the opening of a paint spray gun that is held in an upside down position. The paint spray gun is subsequently turned over such that the fluid reservoir is situated on the upper side of the paint spray gun. The venting of the fluid reservoir is realized, e.g., by the opening of a vent valve provided on the bottom of the fluid reservoir or by piercing an initially closed venting duct with the aid of a pin or the like. The utilization of a vent valve that can be reclosed after the paint spray gun is used or a vent opening that can be resealed provides the advantage that the fluid reservoir can also be used for storing paint that was not used in its entirety.

1-9. (canceled)

10. A fluid reservoir for a paint spray gun with a cup shaped reservoir (1), a cover (2) that can be attached to the reservoir (1) and a connecting part (3) that is integrally molded on reservoir (1) or on the cover (2) and serves for fixing the fluid reservoir on a paint spray gun, characterized by the fact that at transition area (12) between the connecting part (3) and the reservoir (1) or the cove r (2) is realized in a flexible fashion in order to adjust the inclination of the central axis (13) of the reservoir (1) or the cover (2) relative to the central axis (14) of the connecting part (3).

11. The fluid reservoir according to claim 10, characterized by the fact that the wall thickness changes from a greater wall thickness on the connecting part (3) to a lesser wall thickness on the reservoir (1) or the cover (3) at the transition area (12) between the connecting part (3) and the reservoir (1) or the cover (2).

12. The fluid reservoir according to claim 11, characterized by the fact that the difference in the wall thickness at the transition from the connecting part (3) to the reservoir (1) or the cover (2) amounts to at least 30%.

13. The fluid reservoir according to claim 10, characterized by fact that a radius (15) is provided at the transition from the connecting part (3) to the reservoir (1) or the cover (2).

14. The fluid reservoir according to claim 10, characterized by the fact that the transition area (12) is realized similar to a bellows.

15. The fluid reservoir according to claim 10, characterized by the fact that the connecting part (2) features a screw type wedge element (9, 10) for realizing a rapid action coupling between the fluid reservoir and the paint spray gun.

16. The fluid reservoir according to claim 15, characterized by the fact that the screw type wedge element (9, 10) is formed by a wedge shaped projection (9) with a wedge surface (10) that extends over approximately half the circumference of the connecting part (3) and engages with a corresponding mating surface on an attachment or projection of the paint spray gun.

17. The fluid reservoir according to claim 16, characterized by the fact that the rapid action coupling thread (18, 19) consists of a steep quadruple thread, wherein the external thread (18) is arranged on the upper end of the circumference of the reservoir (1) and the corresponding internal thread (19) is arranged on the inner side of the cover (2).

18. The fluid reservoir according to claim 10, characterized by the fact that the connecting part (3) features an external thread (6) for being screwed into a conventional internal thread.

19. The fluid reservoir according to claim 10, characterized by the fact that the reservoir (1) and/or the cover (2) featuring the connecting part (3) consist(s) of an elastic non embrittling plastic material, preferably PE or a plastic material with a high PE content.
